(19) United States
(12) Patent Application Publication
(10) Pub. No.: US 2007/0232818 A1
(43) Pub. Date: Oct. 4, 2007

(54) TRANSESTERIFICATION OF OIL TO FORM BIODIESELS

(75) Inventors: John W. Crawford, Tempe, AZ (US); James M. Crawford, Salem, UT (US); Ronald Crafts, Orem, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: DOMESTIC ENERGY LEASING, LLC, Orem, UT (US)

(21) Appl. No.: 11/559,779

(22) Filed: Nov. 14, 2006

Related U.S. Application Data
(60) Provisional application No. 60/736,674, filed on Nov. 15, 2005.

(51) Int. Cl. C11B 7/00; B01J 14/00

(52) U.S. Cl. 554/174; 422/129

(57) ABSTRACT

The systems and methods for producing biodiesel using a transesterification process include reacting alcohol and a triglyceride oil to form biodiesel and glycerin. The glycerin is periodically or continuously removed from the reaction mixture so as to drive the equilibrium reaction toward completion. The process can be performed continuously or using a batch process. The process may optionally employ a catalyst.

### RELATED APPLICATIONS

The present application claims the benefit of U.S. Provisional Patent Application Ser. No. 60/736,674 filed Nov. 15. 2005, the disclosure of which is incorporated by reference in its entirety.

### BACKGROUND OF THE INVENTION

1. The Field of the Invention

The present invention relates to transesterification of oil in an alcohol. More particularly, the present invention relates to transesterification processes, systems, and methods for commercial production of biodiesels.

2. The Relevant Technology

Biodiesels have the potential to become an important fuel source. While fossil fuel sources are non-renewable, biodiesels, in contrast, provide a renewable fuel source. Further, unlike fossil-fuel sources, biodiesels tend to have less of an effect on the environment because they are biodegradable, non-toxic and produce relatively low emissions.

Biodiesels are derived from oils such as vegetable oils and/or animal fats. Such vegetable oils and/or animal fats can be reacted with an alcohol (e.g., a simple alcohol such as methanol and/or ethanol) to produce biodiesel, using a process known as transesterification. One exemplary transesterification reaction is shown as follows:

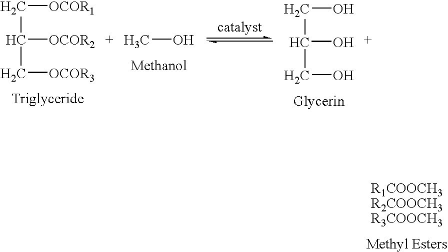

In this illustrated reaction, a triglyceride molecule, having three long chain fatty acids bonded to a single glycerol molecule, is reacted with methanol to form three methyl esters and glycerol (also referred to herein as glycerin). The methyl ester can be used as a biodiesel fuel.

In the transesterification reaction, the biodiesel product and glycerin are in chemical equilibrium with the oil and alcohol. To drive the reaction toward the production of biodiesel products, current processes use a large excess of alcohol. For example, one study suggests an optimum molar ratio of alcohol to triglyceride of 42:1 at supercritical temperatures and pressures in order to produce a significant fraction of biodiesel.

A typical batch type supercritical transesterification system 10 is illustrated schematically in FIG. 1. Typically, a charge of triglyceride oil and methanol is placed in a reaction chamber 12. Chamber 12 is then heated and pressurized. Chamber 12 may be surrounded by electrical furnace 14, which provides the necessary heat to chamber 12. Temperature monitoring and control is provided by temperature control monitor 16, while pressure control monitor 18 provides control and monitoring of the pressure within reaction chamber 12. Reaction products are removed through product exit valve 20, and the products are passed through condenser 22, where they may be cooled and delivered to product collection vessel 24. The reaction products must then be separated into biodiesel, glycerin, any unreacted triglyceride, and excess methanol.

Reaction rates in a typical supercritical batch system as shown in FIG. 1 result in a rapid slowing of the reaction rate with low molar ratios of alcohol to triglyceride oil (e.g., anything near the stoichiometric ratio of 3:1). The percentage of conversion is also significantly reduced. Thus, a commercial system using a very high molar ratio of alcohol to triglyceride oil, for example 42:1, may have acceptable reaction rates and percentage of conversion, but would require more than 40 times the molar volume of alcohol versus triglyceride. As can be seen, this results in an extremely expensive and inefficient process. Further, because of the large amount of alcohol required, equipment costs increase dramatically, along with increased maintenance and handling costs. All of this difficulty is further complicated because of the high temperatures and pressures at which such a system typically must operate.

Because of the dramatically increased expenses associated with using an extreme excess of alcohol, a suitable alternative process for commercially producing biodiesels is needed.

### BRIEF SUMMARY OF THE PREFERRED EMBODIMENTS

The present invention relates to systems and methods for manufacturing biodiesel from triglyceride oils. In the process of the invention, triglycerides are transesterified using an alcohol to yield an alkyl ester and glycerin. The transesterification reaction is driven toward the formation of alkyl esters (i.e., biodiesel products) by removing glycerin. Removing a portion of the glycerin from the reaction mixture allows the reaction to be carried out with lower ratios of alcohol to oil and/or with increased rates of production for biodiesel products.

In one embodiment of the invention, the transesterification reaction is carried out according to the following reaction,

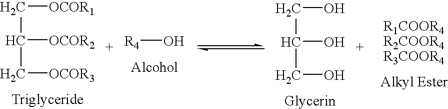

The foregoing transesterification reaction can be carried out using any triglyceride oil feedstock, including vegetable oils and/or animal fats, whether edible or inedible. Examples of suitable vegetable oil feedstocks include castor oil, coconut oil, corn oil, cottonseed oil, flax oil, hemp oil, mustard oil, palm oil, peanut oil, radish oil, rapeseed oil, ramtil oil, rice bran oil, safflower oil, soybean oil, sunflower oil, tung oil, and algae oil, and the like.

The alcohol used in the transesterification reaction can be any alcohol capable of alcoholysis of the ester bond between the fatty acid and the glycerol of the triglyceride molecule. In one embodiment, the alcohol is a simple alcohol having between 1 and 4 carbons. Examples of suitable alcohols include methanol, ethanol, butanol, or a combination of these.

The removal of glycerin is transesterification reaction is carried out in a reaction vessel or system that allows glycerin to be separated from the reaction mixture during the transesterification process. The glycerin can be separated from the reaction mixture using any suitable technique, including, but not limited to, centrifugation or a settling vessel. The removal of the glycerin can be continuous, semi-continuous, or between batch reactions.

In one embodiment, the glycerin formed during the transesterification reaction is drawn off at a rate that maintains a desired ratio of alcohol to triglyceride oil. Alternatively the glycerin can be drawn off to maintain the ratio of alcohol to triglyceride oil within a desired range. Typical ratios of alcohol and triglyceride may range from 3:1 to 40:1. Maintaining a desired ratio of alcohol to triglyceride oil can be achieved using a continuous, semicontinuous, or batch process.

The transesterification process of the present invention significantly improves the efficiency of manufacturing biodiesel from triglycerides by increasing the rate of biodiesel production and/or by reducing the concentration of alcohol needed to drive the reaction towards production of biodiesel products at a given rate. The increased reaction rate and/or reduced volume of alcohol needed to drive the reaction significantly reduces capital costs for manufacturing biodiesel, particularly for large scale biodiesel production.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a typical batch type supercritical transesterification system;

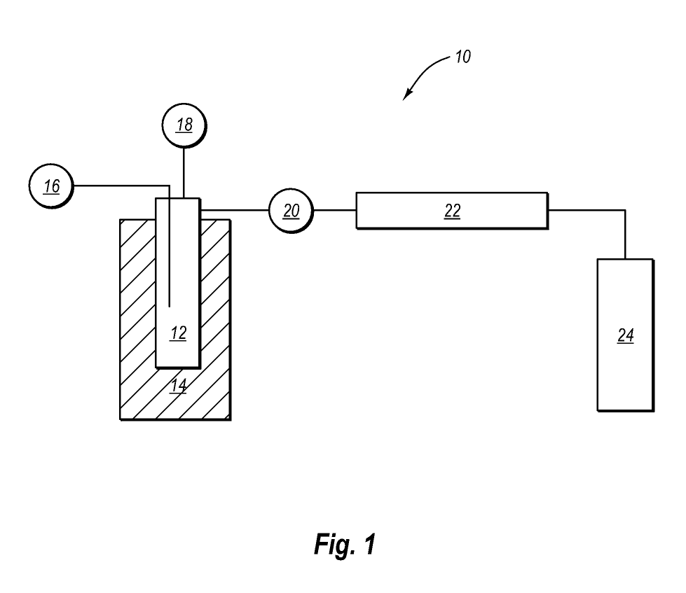

FIG. 2 illustrates an exemplary continuous process system according to the present invention;

FIG. 3 illustrates an alternative continuous process system according to the present invention;

FIG. 4 is a cross-sectional view of an exemplary centrifuge separator;

FIG. 5 is a schematic view of an exemplary cyclonic separator;

FIG. 6 is a graph charting reaction time versus the percentage conversion for several molar ratios of alcohol to triglyceride oil, and for an example of the inventive reaction process;

FIG. 7 is a graph charting reaction time versus percentage conversion at a molar ratio of 3.5 parts alcohol to 1 part triglyceride oil for both the inventive process where glycerin is continuously or periodically withdrawn, and a comparative example where glycerin is not withdrawn; and

FIG. 8 illustrates an exemplary alternative batch process system according to the present invention.

### DETAILED DESCRIPTION

I. Introduction

The present invention relates to systems and methods for performing transesterification processes on triglyceride oils using an alcohol, such as a simple alcohol (e.g., alcohols having 1-4 carbon atoms).

The scope of the present invention encompasses both continuous reaction processes and batch reaction processes. During the transesterification process, glycerol formed during the process is drawn off periodically or continuously, so as to maintain the ratio of alcohol to oil at a relatively high concentration, while also lowering the glycerin product concentration, both of which have the effect of driving the reaction equilibrium towards completion (i.e., production of biodiesel products). Advantageously, this reduces the amount of alcohol needed to drive the reaction, while still providing relatively high conversion rates for biodiesel production.

In one embodiment, the glycerin can be drawn off at a molar ratio proportional to the reaction rate. That is, for faster reaction rate conditions, the removal rate of glycerin is higher, and for slower reaction rate conditions, the removal rate is slower. Alternatively, for slower reaction rate conditions, glycerin can be drawn off at a faster rate to help increase the rate of reaction. For example, in one embodiment, where the alcohol and triglyceride oil are fed continuously and the glycerin is drawn off continuously, the volume of methanol input versus volume of glycerin drawn off may advantageously be from about 3.5:0.9 to about 6:1. These volumetric ratios correspond to a molar ratio of methanol input versus glycerin drawn off from about 7:1 to about 11:1. It will be understood, however, that other ratios of methanol input versus glycerin drawn off are possible.

II. Transesterification Process

In one embodiment of the invention the transesterification process is carried out according to the following formula.

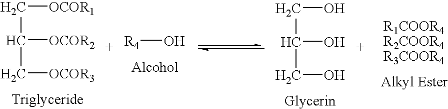

As shown in this formula, the reactants (i.e., triglyceride and alcohol) are in equilibrium with the products (i.e., alkyl esters and glycerin). The conversion of triglycerides to alkyl esters is favored by removing glycerin and optionally maintaining an excess of alcohol.

The triglyceride feedstock can be any vegetable oil or animal fat having fatty acid groups suitable for use as a biodiesel. In the foregoing formula, R¹-R³ can be a long chain hydrocarbon corresponding to the alkyl portion of a fatty acid suitable for use as biodiesel. In one embodiment, R¹-R³ can independently be a saturated or unsaturated, branched or unbranched, substituted or unsubstituted alkyl with 7-20 carbons.

Examples of suitable vegetable oil feedstocks include castor oil, coconut oil, corn oil, cottonseed oil, flax oil, hemp oil, mustard oil, palm oil, peanut oil, radish oil, rapeseed oil, ramtil oil, rice bran oil, safflower oil, soybean oil, sunflower oil, tung oil, and algae oil, and the like.

In addition to the triglyceride, the transesterification reaction is carried out using one or more alcohols. In one embodiment, the alcohol is a simple alcohol having between 1 and 4 carbons (i.e., R⁴ is an alkyl from 1 to 4 carbons). Examples of suitable alcohols include methanol or ethanol, or a combination of these.

The molar ratio of alcohol to triglyceride oil affects the conversion rate of triglyceride oil to alkyl ester (i.e., biodiesel). While any molar ratio of alcohol to triglyceride oil can be used in the present inventive method, because the present invention provides very high conversion rates in a short reaction time at lower molar ratios, relatively low molar ratios may be used as compared to known alcoholysis processes. In one embodiment, the molar ratios of alcohol to triglycerides can be in a range from about 3:1 to about 40:1. Alternatively, the range can be from about 3.5:1 to about 10:1 or from about 3.5:1 to about 6:1.

Reaction rates for the transesterification process of the invention can also depend on the temperature of the reaction mixture. The particular temperature selected can depend on the particular triglycerides being converted and the particular alcohol being used. Examples of suitable reaction temperatures include, but are not limited to, about 25° C. to about 200° C., alternatively in a range from about 200° C. to about 500° C., alternatively in a range from about 240° C. to about 400° C., a range from out 270° C. to about 400° C., or a range from about 300° C. to about 400° C. Other temperatures and pressures can be used as needed for a particular reaction mixture and/or reactor configuration. The temperature is typically selected in combination with the pressure. Examples of suitable pressures include about 0 psi to about 5000 psi.

The transesterification processes can optionally employ one or more catalysts. A catalyst system may include soluble catalysts, enzyme catalysts, heterogeneous catalysts, Brownsted acid catalysts, and/or alkali catalysts. Alkali catalyst include, but are not limited to, sodium hydroxide, sodium methoxide, potassium hydroxide, and/or potassium methozide. Brownsted acid catalysts include, but are not limited to, sulfonic acid, sulfuric acid, phosphoric acid, hydrochloric acid and/or organic sulfonic acid. It will be understood by one skilled in the art that various other catalysts can be used to obtain the desired benefit.

In one embodiment, the catalyst employed in the transesterification reaction is a heterogenous catalyst. The heterogenous catalyst can be a solid catalysts that includes one or more of the following: transition metals including metals or metal compounds from Group VIB, including chromium or its compounds; transition metals from Group VIII, including iron, nickel, platinum, or their compounds; porous inorganic oxides including zeolites; alkali metals or their compounds, including sodium, potassium, or their compounds; alkaline earth metals or their compounds, including calcium or magnesium or their compounds. Solid catalysts that include transition metals and porous inorganic oxide catalysts have surprisingly been found to work well with the glycerin removal process of the invention.

The type of catalyst(s) and the temperature and pressure of the reaction will typically depend on the type of oil, type of alcohol, the molar ratio of alcohol to oil, the amount of catalyst, reaction time, reaction temperature, and reaction pressure. For example, in one embodiment, a first step may include using an acid catalyzed pretreatment and a second step may use an alkaline catalyst for reaction completion.

III. Example Systems and Methods

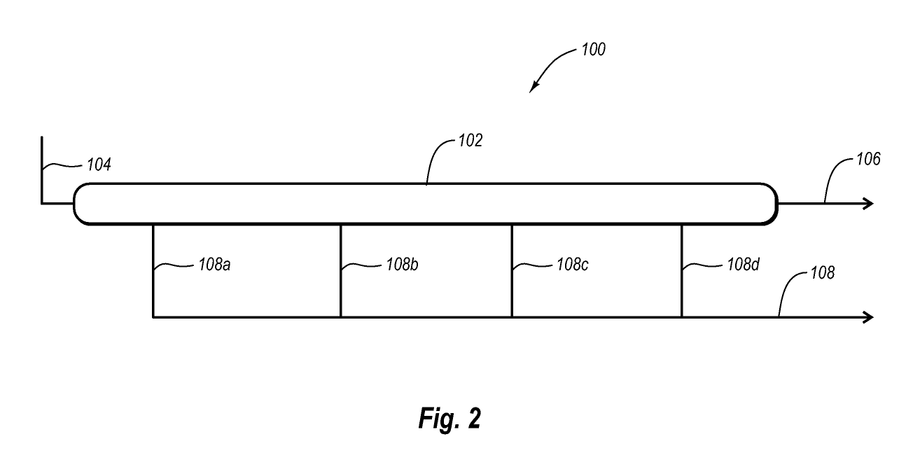

FIG. 2 schematically illustrates an exemplary system 100 for performing a continuous transesterification process according to the present invention. System 100 includes a horizontally disposed reaction chamber 102 with an inlet 104 and an outlet 106. At a plurality of spaced apart locations along reaction chamber 102 are located glycerin removal points 108a-108d. Alcohol and oil are continuously fed into reaction chamber 102 through inlet 104, and as the reaction proceeds at supercritical temperature and pressure, the alcohol and oil are converted to biodiesel and glycerin. Because glycerin is significantly more dense than biodiesel, alcohol and the triglyceride oil feedstock, it naturally settles to the bottom of horizontally disposed reaction chamber 102. The glycerin 108 may be drawn off at the various glycerin removal points 108a-108d using any of various separation techniques, which will be described in further detail below. Glycerin can be drawn off periodically or continuously.

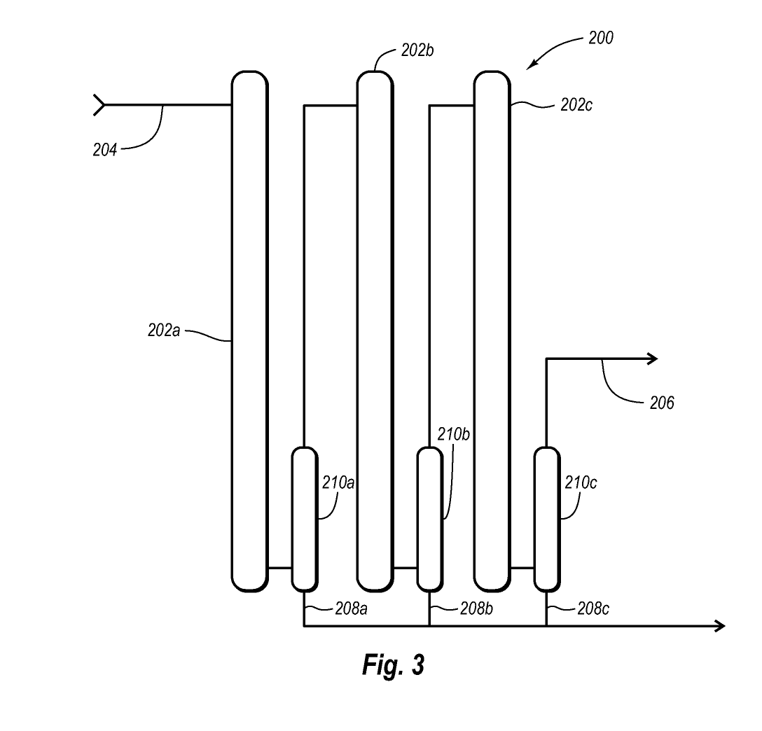

FIG. 3 schematically illustrates an alternative system 200 for performing continuous transesterification reactions according to the present invention. System 200 includes multiple reaction chambers 202a, 202b, and 202c, each reaction chamber being vertically disposed, with the multiple reaction chambers being connected in series. Although illustrated with three reaction chambers, it is to be understood that any number may be used. A first inlet 204 provides feed to first reaction chamber 202a, and a final outlet 206 withdraws product from final reaction chamber 202c. A separator may advantageously be disposed after each reaction chamber. For example, separator 210a is disposed between reaction chambers 202a and 202b, separator 210b is disposed between reaction chambers 202b and 202c, and separator 210c is disposed after reaction chamber 202c. Each separator draws material from near the bottom of its associated reaction chamber, where the glycerin product will tend to settle due to its relatively high density. Each separator may include an associated glycerin removal point (i.e., 208a-208c, respectively). Separators 210a-210c draw off the glycerin between each reaction chamber, and the reduced-glycerin mixture is sent on to the inlet of the next reaction chamber. Thus, glycerin can be drawn off in a continuous manner after each of reaction chambers 202a-202c. The reaction mixture may advantageously be cooled at each separator 210a-210c to facilitate easier separation of the glycerin from the remainder of the reaction mixture. Because glycerin will be drawn off at each separator 210a-210c, and only the remaining components passed onto the subsequent reactor, the alcohol and triglyceride oil component concentrations are increased, and the glycerin product concentration is decreased, also raising the alcohol to triglyceride oil ratio so as to drive the reaction toward the desired products (i.e., biodiesel).

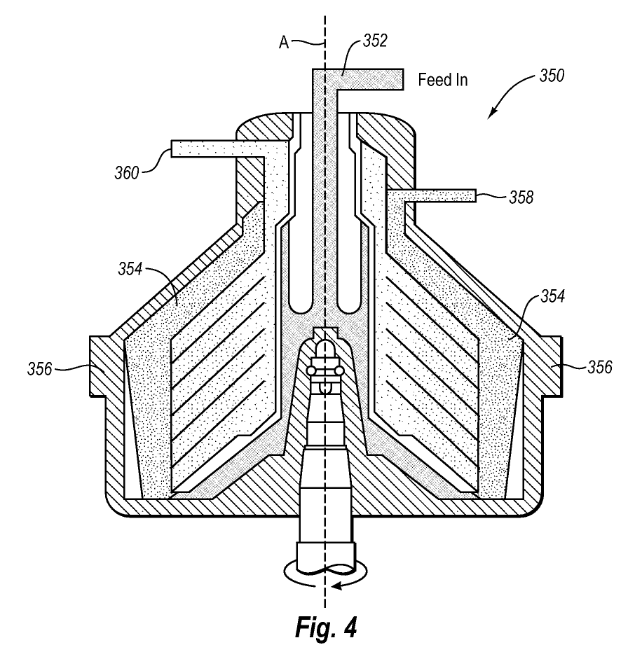

Any suitable separating means may be used with the system of the present invention. The separators function to separate the glycerin from the other reactants and products in the reaction mixture. In one embodiment, separators 210a-210c may be mechanical separators. A centrifugal separator 350, illustrated in FIG. 4, is one example of a mechanical separator. Mechanical separators function by imparting radial motion to an incoming feed stream (e.g., through use of discs or vanes). This motion generates centrifugal force which causes a stratification of the incoming feed 352 based upon the relative densities of the components within the feed stream. In the illustrated separator 350, the device is rotated about a longitudinal axis A, which causes the most dense components (i.e., glycerin) within the mixture to move outwardly to a region 354 against the outer wall 356 of separator 350. The other components within the mixture are also stratified according to their relative densities so that the least dense components are disposed towards the center of separator 350, nearest longitudinal axis A. For example, glycerin has a density of about 1.3 kg/L, biodiesel has a density of about 0.9 kg/L, methanol has a density of about 0.8 kg/L, and a typical triglyceride oil feed (e.g., rapeseed oil) has a density of about 0.92 kg/L.

The high density glycerin is withdrawn from outlet 358, while the lighter mixture of biodiesel product and unreacted methanol and triglyceride oil may be withdrawn from outlet 360. Because of the large difference in density between the glycerin and the other components within the feedstream mixture 352, it is relatively simple to separate and withdraw the glycerin from the reaction mixture. In other words, the glycerin has a density that is about 45 percent greater than any other component within the mixture.

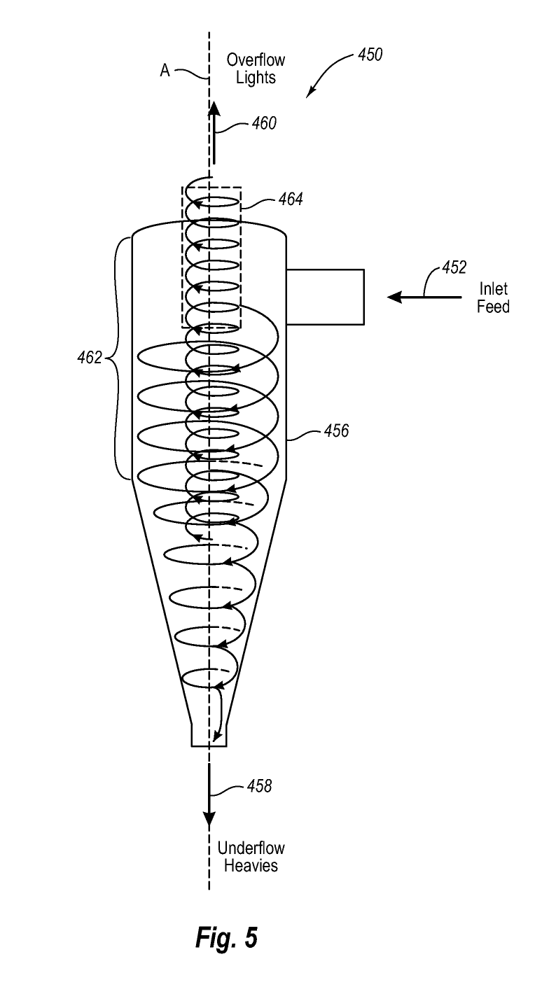

In another embodiment, as illustrated in FIG. 5, a cyclonic separator 450 can be used to separate the glycerin from the remainder of the reaction mixture. A cyclonic separator operates as a passive device using only the centrifugal force generated from the tangential induction of the feed material to induce stratification of the various components, again based upon the relative densities of each component. Cyclonic separator 450 includes an inlet 452, a first outlet 458, and a second outlet 460. An outer wall 456 defines an upper portion 462 having a cylindrical cross section. As feed material enters through inlet 452, the material moves in a circular pattern around the separator 450. The combination of gravity and centrifugal force created by the spinning feedstream forces the denser components downward and to the outer edges, near wall 456, while the relatively light components remain relatively higher and closer to the longitudinal axis A of the separator 450. The heavier components (typically high purity glycerin) are removed from separator 450 via the lower outlet 458. Lighter components exit through a vortex finder 464 and second outlet 460 located at the top of separator 450. Cyclone separators advantageously have no moving parts, making them inexpensive to maintain and operate. Although cyclone separators typically may not provide as efficient separation as a centrifuge separator, because of the very large difference in density between the glycerin and the other components, it is more than satisfactory. Furthermore, multiple cyclone separators (or other types of separators) may be used in series to provide a better separation (i.e., deliver a higher purity glycerin).

Other separation methods and devices may be used—including, but not limited to, vane separators, coalescing separators, gravimetric separators, a simple passive settling tank, a filter membrane separator, or a reverse osmosis or dialysis type filter.

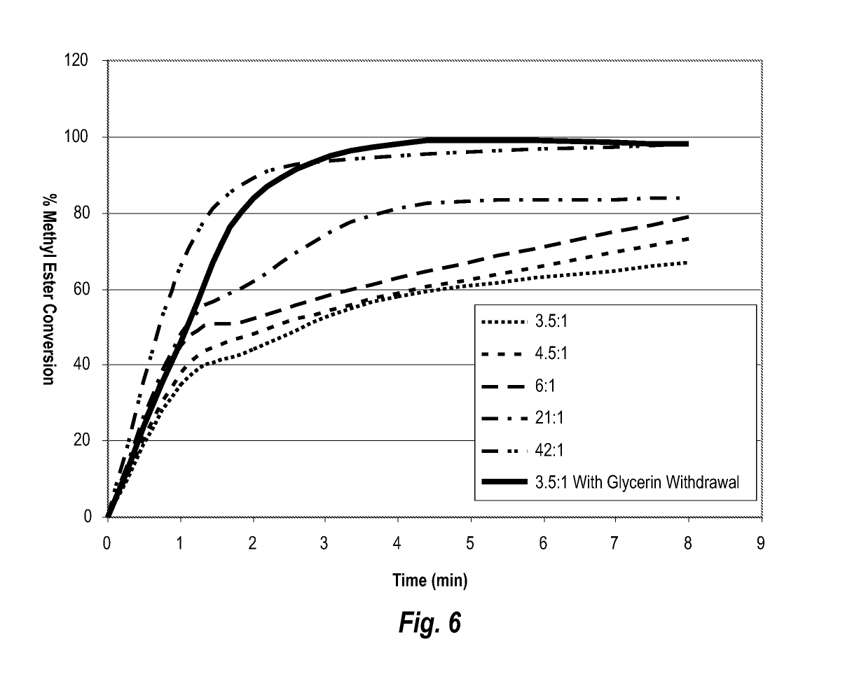

The removal of reaction product (e.g., glycerin) provides the advantage of allowing an initial feed having a lower ratio of alcohol to triglyceride oil than was previously thought possible. As shown in FIG. 6, various molar ratios without glycerin removal are compared to an example of the inventive process that incorporates drawing off glycerin product periodically or continuously. As seen in FIG. 6, at a molar ratio of alcohol to triglyceride oil of about 3.5:1, after about 2 minutes, the percent of triglyceride oil converted is about 43 percent, and after about 8 minutes, the percent conversion is about 65 percent. At higher molar ratios of alcohol to triglyceride oil (e.g., about 4.5:1, about 6:1, about 21:1 and about 42:1), the percent conversion is greater. For example, at a ratio of about 42:1, the percent conversion is about 90 percent after 2 minutes and about 95 percent after 5 minutes). Advantageously, at a molar ratio of about 3.5:1 and while drawing off the glycerin product, the percent conversion is about 85 percent after 2 minutes and nearly 100 percent (e.g., at least 99 percent) after 5 minutes. Drawing off glycerin product advantageously provides for very high conversion rates (i.e., at least 95 percent after about 3 to 4 minutes), while also allowing the reaction to proceed with only a very small excess of alcohol (e.g., about 3.5:1) relative to the quantity of triglyceride oil in the feed. Furthermore, the experiments conducted indicate that satisfactory results could also be obtained with no or substantially no excess of alcohol (i.e., at or near the stoichiometric molar ratio of alcohol to triglyceride oil of 3:1)

As shown in FIG. 6, of the processes without glycerin removal, a molar ratio of alcohol to triglyceride oil of about 42:1 produced the best results over time. However, using the process of the present invention incorporating glycerin removal, a molar ratio of alcohol to oil of only about 3.5:1 produces similar conversion rates as the prior art process. This results in a 1200% decrease in volume of alcohol (e.g., methanol), required to obtain the same yield of biodiesel product. Not only does this represent reduced reactant costs, but also reduced costs for equipment and maintenance, resulting in an extremely cost-effective method of producing high yields of biodiesel.

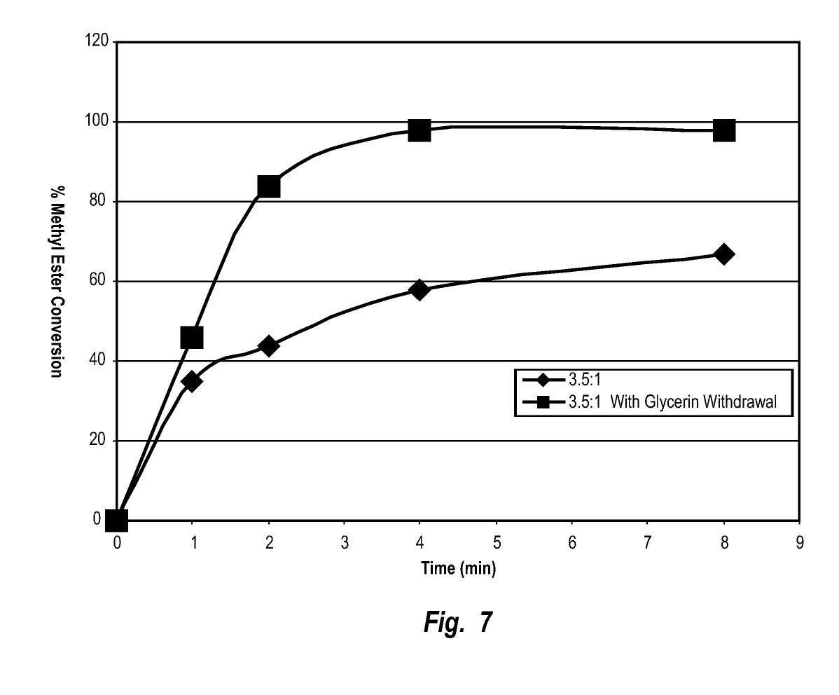

Further, as shown in FIG. 7, when compared to a traditional process that uses a molar ratio of alcohol to triglyceride oil of about 3.5 to 1, but does not incorporate glycerin removal, relative to the inventive process incorporating glycerin removal and using the same molar ratio of about 3.5 to 1, the inventive process results in an increase in yield of about 34%, and in less time. Thus, by employing glycerin extraction in the production of methyl esters (biodiesel), at comparable methanol molar concentrations, the process that incorporates the removal of glycerin results in both faster reaction rate (i.e., substantially complete after about 4 minutes as compared to about 8 minutes or more) and higher final yield (i.e., about 99 percent as compared to about 65 percent).

While any molar ratio of alcohol to triglyceride oil can be used in the present inventive method, because the present invention provides very high conversion rates in a short reaction time at lower molar ratios, it is preferable that relatively low molar ratios be incorporated into commercial embodiments of the present invention. Thus, suitable molar ratios for the present invention can be from about 3:1 to about 20:1, with about 3.5:1 to about 10:1 being preferred, and about 3.5:1 to about 6:1 being even more preferred.

Exemplary suitable reaction times (e.g., reactor residence time for either a continuous or batch process) may range from a few minutes (e.g., 2 to 5 minutes) up to 1 hour, depending on the temperature and pressure. It will be understood, however, that reaction times above and below those described herein are also possible.

The temperature and pressure used within the system depends upon the reaction conditions. For instance, the supercritical state of methanol, in a reaction with rapeseed oil, can be achieved with a temperature of about 239° C. and a pressure of 8.09 MPa. Other temperatures and pressures may be used with the inventive process. For instance, suitable temperatures are preferably between about 200° C. to about 500° C., more preferably between about 240° C. to about 400° C., more preferably between about 270° C. to about 400° C., even more preferably between about 300° C. to about 400° C., and even more preferably about 350° C. Alternatively, other temperatures and pressures may be evident to those skilled in the art based upon the disclosure of the invention herein. For instance, and not by way of limitation, even at lower temperatures (e.g., 200° C. to 230° C.), yields of 68-70% can be obtained, but typically require longer reaction times.

Of course the temperature and pressure at which the reaction is carried out may vary depending on the type of oil, type of alcohol, the molar ratio of alcohol to oil, and desired reaction times. For embodiments not employing a catalyst, stirring is not generally required at supercritical temperatures and pressures because the oil/alcohol mixture forms a single phase. However, stirring may be implemented at any desired temperature and/or pressure, whether such temperatures and/or pressures are supercritical or not.

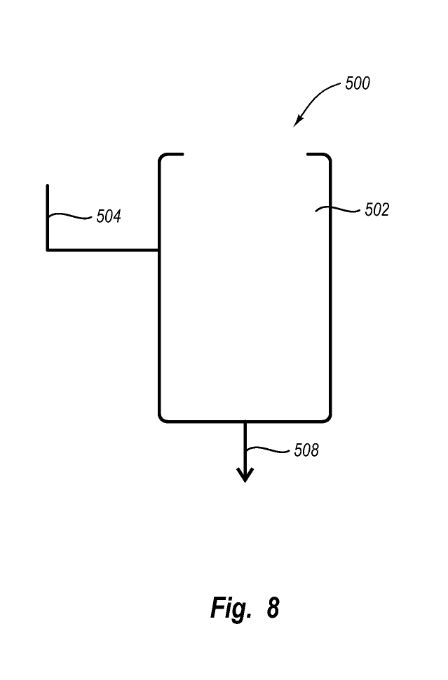

While continuous reactor embodiments according to the present invention have been described above, the present invention may also be performed in a batch reactor system. A batch reactor system 500 is shown in FIG. 8. System 500 includes a reaction vessel 502 and an inlet/outlet port 504. In addition, the vessel 502 may include a glycerin removal outlet 508. During the batch reaction, as glycerin forms, its density will cause it to settle to the bottom of the reaction vessel 502, where a valve or other structure can be used to release the glycerin that is produced during the reaction and periodically draw off the glycerin.

The present invention also extends to transesterification processes that employ one or more catalysts. That is, even in the presence of a catalyst, the reaction rate and yield is still at least partially controlled by the concentration of the alcohol relative to triglyceride oil. A transesterification process using a catalyst may include any of the above described continuous or batch systems. The reaction feed of alcohol and triglyceride oil may be fed through the reaction vessels containing a catalyst bed. Due to the two-phase nature of the oil/alcohol mixture, when a catalyst is used, vigorous stirring is typically performed. During the catalyst reaction, a given percentage of the oil is converted to biodiesel and glycerin. As described above, the glycerin may advantageously be removed periodically or continuously. The unreacted triglycerides may also be recycled back into the reaction vessel.

When a catalyst is used, it may not be necessary to use supercritical temperatures and/or pressures, exemplary temperatures can range from about 30° C. to about 65° C., with exemplary reaction times of about 0.1 hour to about 1 hour, and a molar ratio of alcohol to oil of about 3:1 to about 6:1. It will be understood, however, that other temperatures, pressures, reaction times, and molar ratios above and below those described herein are also possible.

### IV. EXAMPLES

The following examples provide reaction mixtures and conditions for carrying out example transesterification reactions according to the present invention to produce biodiesel.

### Example 1

Example 1 provides example ranges suitable for carrying out the invention with a soluble catalyst. An amount of vegetable oil is mixed with 3-6 mol of alcohol per mol of oil and 3-6 grams of soluble catalyst per liter of oil. The mixture is maintained at a temperature between 10° C. and 150° C. and a pressure between ambient and 500° C. This mixture is circulated through a mixing chamber and centrifugal separator in a continuous flow-through loop. Glycerin is removed from the mixing stream on a continuous basis. Additional methanol and sodium hydroxide is added as needed to compensate for loss dissolved in the removed glycerin. Processing continues until glycerin production ceases.

### Example 2

Example 2 describes a specific example of a transesterification reaction carried out according to one example embodiment of the invention. The process was carried out using the procedure of Example 1 where 1 liter of vegetable oil was mixed with 200 ml of methanol and 3.5 g of sodium hydroxide at ambient temperature and pressure. The glycerin was removed using centrifugation.

### Example 3

Example 3 describes a transesterification process according to one example embodiment of the invention. The process of Example 3 was carried out identical to the process in Example 2, except that potassium hydroxide was substituted for sodium hydroxide and the glycerin was removed using a gravimetric technique.

### Example 4

Example 4 describes a transesterification process according to one example embodiment of the invention. The process of Example 4 was carried out using 6-40 moles of alcohol per mole of oil and about 1 kg, of heterogeneous catalyst. The mixture was maintained at 200-400° C. under 1000-5000 psi. Glycerine was drawn off using a gravimetric technique until glycerin production ceased.

### Example 5

Example 5 describes several separate transesterification reactions according to the invention where the heterogeneous catalyst was separately nickel, chromium, platinum, or zeolite. The transesterification reaction of Example 5 was carried out in four separate reactions using the procedure of Example 4 where the heterogeneous catalyst used was nickel, chromium, platinum, and zeolite, respectively.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A process for performing transesterification of a triglyceride oil for producing biodiesel, the process comprising:
reacting alcohol and a triglyceride oil, the reaction yielding a product comprising biodiesel and glycerin;
separating at least a portion of the glycerin from the product; and
allowing the alcohol and oil to react to form more product.

2. A process as recited in claim 1, wherein the process is a continuous type reaction process.

3. A process as recited in claim 1, wherein the process is a batch type reaction process.

4. A process as recited in claim 1, wherein the alcohol comprises methanol or ethanol.

5. A process as recited in claim 1, wherein the triglyceride oil comprises a vegetable oil.

6. A process as recited in claim 5, wherein the vegetable oil comprises rapeseed oil.

7. A process as recited in claim 1, wherein the glycerin is continuously withdrawn.

8. A process as recited in claim 1, wherein the glycerin is periodically withdrawn.

9. A process as recited in claim 1, wherein the molar ratio of alcohol to triglyceride is between about 3:1 and about 20:1.

10. A process as recited in claim 1, wherein the molar ratio of alcohol to triglyceride is between about 3.5:1 and about 10:1.

11. A process as recited in claim 1, wherein the molar ratio of alcohol to triglyceride is between about 3.5:1 and about 6:1.

12. A process as recited in claim 1, wherein the reaction time is between about 2 minutes and about 1 hour.

13. A process as recited in claim 1, wherein the reaction time is no more than about 4 minutes and the percent conversion of triglyceride oil is greater than about 95 percent.

14. A process as recited in claim 1, wherein the reaction is carried out at supercritical temperature and/or pressure.

15. A process as recited in claim 1, wherein the reaction of the alcohol and oil is carried out in the presence of a solid catalyst.

16. A process as recited in claim 15, wherein the solid catalyst is selected from the group consisting of platinum, nickel, chromium, zeolites, and combinations thereof.

17. A system for performing transesterification of a triglyceride oil for producing biodiesel, the system comprising:
an input for introducing alcohol and a triglyceride oil into a reaction chamber;
at least one reaction chamber containing a reaction mixture in which alcohol and a triglyceride oil react so as to yield a product comprising biodiesel and glycerin, the product being intermixed with unreacted alcohol and optionally unreacted triglyceride oil within the reaction mixture;
means for separating at least a portion of the glycerin from the reaction mixture so as to allow the alcohol and triglyceride oil to form more product; and
an outlet for withdrawing biodiesel and unreacted alcohol.

18. A system as recited in claim 17, wherein means for separating at least a portion of the glycerin from the reaction mixture comprises a mechanical separator.

19. A system as recited in claim 18, wherein the mechanical separator comprises at least one of a centrifuge or a cyclonic separator.

20. A system as recited in claim 17, wherein the system comprises a plurality of reaction chambers in series.

21. A system as recited in claim 20, wherein the means for separating at least a portion of the glycerin from the reaction mixture comprises a separator disposed after each reaction chamber.

22. A system as recited in claim 17, further comprising a catalyst for catalyzing the reaction of alcohol and triglyceride oil.

23. A system for performing transesterification of a triglyceride oil for producing biodiesel, the system comprising:
an input for introducing alcohol and a triglyceride oil into a reaction chamber;
at least one reaction chamber containing a reaction mixture in which alcohol and a triglyceride oil react so as to yield a product comprising biodiesel and glycerin, the product being intermixed with unreacted alcohol and optionally unreacted triglyceride oil within the reaction mixture;
at least one mechanical separator, a mechanical separating being disposed after each reaction chamber for separating at least a portion of the glycerin from the reaction mixture so as to allow the alcohol and triglyceride oil to form more product; and
an outlet for withdrawing biodiesel and unreacted alcohol.
